(19) United States
(12) Patent Application Publication
(10) Pub. No.: US 2024/0158241 A1
(43) Pub. Date: May 16, 2024

(54) SILICA-ENCAPSULATED NANO-PHASE CHANGE MATERIAL AND PREPARATION METHOD THEREOF

(71) Applicants: Nanjing University, Nanjing (CN); HAIAN INSTITUTE OF HIGH-TECH RESEARCH, NANJING UNIVERSITY, Nantong (CN)

(72) Inventors: Shaochun Tang, Nanjing (CN); Suyue Jia, Nanjing (CN); Peng Yang, Nanjing (CN); Hongbin Lu, Nantong (CN); Yang Wu, Nantong (CN); Ye Huang, Nanjing (CN)

(21) Appl. No.: 18/416,907

(22) Filed: Jan. 19, 2024

Related U.S. Application Data
(63) Continuation of application No. PCT/CN2023/132963, filed on Nov. 21, 2023.

(30) Foreign Application Priority Data
Nov. 22, 2022 (CN) 202211463224.7

(51) Int. Cl. C01B 33/145

(52) U.S. Cl. CPC C01B 33/145; C01P 2002/72; C01P 2002/88; C01P 2004/03; C01P 2006/33

(57) ABSTRACT

A silica-encapsulated nano-phase change material and its preparation method are provided. An n-octadecane SiO2 nanoscale phase change material is prepared by sol-gel and microemulsion coupling under alkaline conditions using silica as the shell material and n-octadecane as the core material in a microcapsule and using ethyl n-silicate as the silica source, cetyltrimethylammonium bromide as the emulsifier, and water and ethanol as the solvents. The materials prepared have a particle size of about 500 nm, a phase transition temperature of 27.7° C., a latent heat of phase transition of 159.74 J/g, and an elevated thermal decomposition temperature of 50° C. increase compared with that of the existing n-octadecane.

### TECHNICAL FIELD

The disclosure relates to the technical field of phase change materials, and more specifically, to a silica-encapsulated nano-phase change material and its preparation method.

### TECHNICAL FIELD

An increasing demand for the energy has been raised in the 21st century, with the depletion of traditional energy developing, various new energy sources such as the solar energy, the wind energy, the tidal energy and the like have been emerged. Latent heat energy storage is one of the important application directions of solar energy, which utilizes the property of energy absorbing during the phase change of the material. Solar energy thus can be stored in the material, which has a wide range of applications in real life scenarios such as micro-regulation of the human environment.

Aiming at solving the problems of low thermal conductivity and poor stability of phase change materials, mainstream research mainly focused on two aspects, one is micro-encapsulation technologies and the other is nano-scale phase change materials. Micro-encapsulation technology can improve the performance of phase change materials, such as improving thermal conductivity, energy storage efficiency, etc., the practical application of phase change materials thus becomes possible. The durability of the material has been improved and the specific surface area has been increased. Compared with the traditional materials, the nano-materials have a better performance in terms of electrical conductivity, thermal conductivity, mechanical strength, and chemical stability, etc. The preparation of nano-scale phase change materials has become a way to improve the performance of phase change materials, which can be used to improve the thermal conductivity of phase change materials. thermal conductivity of phase change materials. However, the nano-phase change materials are unstable in solution and in thin films, and are prone to agglomeration, thus affecting the temperature sensitivity of their phase change.

In view of the above, a silica-encapsulated nano-phase change material and a preparation method thereof have been proposed. A silica-encapsulated nano-phase change material is used to effectively improve the thermal conductivity and thermal stability and prevent agglomeration of the nanomaterials, and at the same time, a shell is adopted to the surface of the phase change material by utilizing a micro-encapsulation technologies, which can prevent liquid leakage brought about by the melting of the phase change and improve the thermal stability of the phase change material.

### DETAILED DESCRIPTIONS

The disclosure aims to provide a silica-encapsulated nano-phase change material and a method for its preparation.

Embodiments of the present application disclose a silica-encapsulated nano-phase change material and a preparation method thereof. The preparation includes the steps as follows.

In the step S1, the emulsification of n-octadecane is conducted. The solid n-octadecane containing reagent bottle was placed in a water bath and melted by heating under 60° C. A certain amount of n-octadecane was weighed in a mixed liquid phase of anhydrous ethanol and water for 15 minutes, and an emulsifier was added and processed by sonicated for 50 minutes.

In the step of S2, hydrolytic polycondensation of ethyl orthosilicate is conducted. A certain amount of ethyl orthosilicate was added to the above emulsion of n-octadecane drop by drop by a peristaltic pump and stirred in a magnetic stirrer at a constant temperature of 60° C. for 1 h. A certain amount of ammonia was then added to adjust the pH of the solution, and reacted for a certain period of time at 60° C.

In the step of S3, a centrifugal drying is performed. transfer the obtained sample to a centrifuge tube, centrifuge it at 8000 rpm for 5 min, pour off the upper layer of clear liquid and the n-octadecane that was not wrapped successfully, and wash the white precipitate with anhydrous ethanol and centrifuge it again. This operation was repeated 3 times, and the centrifuged white precipitate was dried in an oven for 24 h.

Preferably, the ratio of anhydrous ethanol to water in step S1 is 1:2.

Preferably, the mass ratio of n-octadecane to ethyl orthosilicate in step S1 and step S2 is 1:1 to 1:3.

Preferably, the emulsifier in step S1 is one or more of cetyltrimethylammonium bromide, Tween 80, Span 80, sodium dodecyl sulfate.

The advantage of the disclosure is that the paraffin-based phase change material has a large phase change temperature range, which is suitable for temperature regulation of the human microenvironment, and it has a large energy storage density during the phase change process, is inexpensive, and has the potential for practical production. An inorganic shell material SiO₂ is wrapped around the exterior of the paraffin-like phase change material, which not only prevents leakage after the paraffin phase becomes liquid, but also exhibits the good thermal conductivity properties of SiO₂.

### BRIEF DESCRIPTION OF THE DRAWINGS

In order to more clearly illustrate the technical solutions in the embodiments or prior art of the present application, the following will briefly introduce the accompanying drawings that need to be used in the description of the embodiments or prior art, and it is obvious that the accompanying drawings in the following description are only some of the embodiments documented in the present application, and other accompanying drawings can be obtained based on these drawings for those with ordinary skill in the field without creative efforts.

FIG. 1A shows the SEM graph of a microcapsule prepared in the embodiment 1;

FIG. 1B shows the SEM graph of a microcapsule prepared in the counterpart embodiment 1;

FIG. 2 shows the XRD graph of a microcapsule prepared in the embodiment 1 and the counterpart Embodiment 1;

FIG. 3 shows the SEM graph of the microcapsules prepared in the embodiment 3;

FIG. 4A shows the SEM graph of a microcapsule prepared in the embodiment 1;

FIG. 4B shows the SEM graph of a microcapsule prepared in the embodiment 4;

FIG. 4C shows the SEM graph of a microcapsule prepared in the embodiment 5;

FIG. 5A shows that TGA diagrams of the n-octadecane;

FIG. 5B shows the TGA graph of a microcapsule prepared in the embodiment 5;

FIG. 5C shows the TGA graph of a microcapsule prepared in the embodiment 1;

FIG. 5D shows the TGA graph of a microcapsule prepared in the embodiment 4.

In the Drawings:

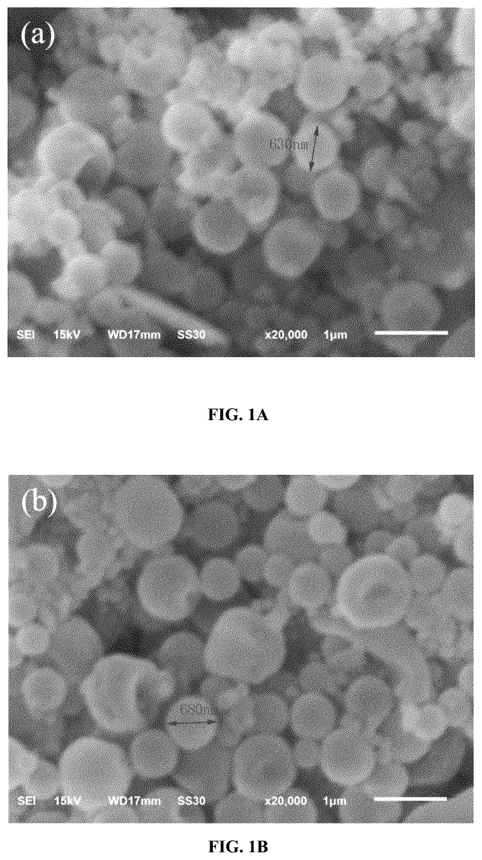

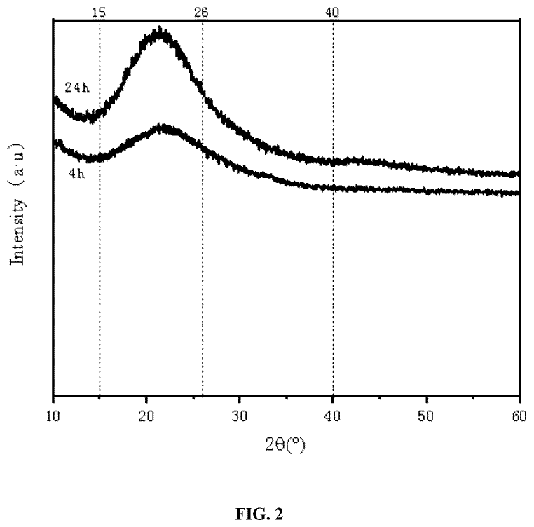

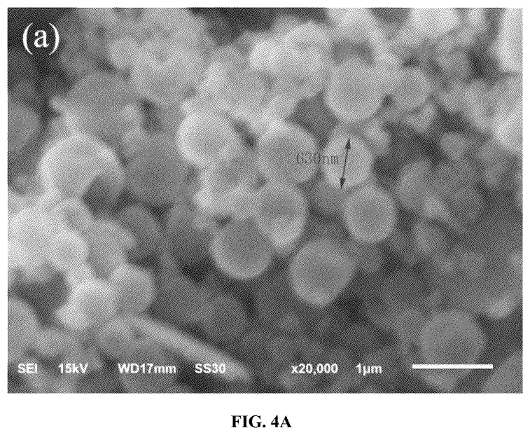

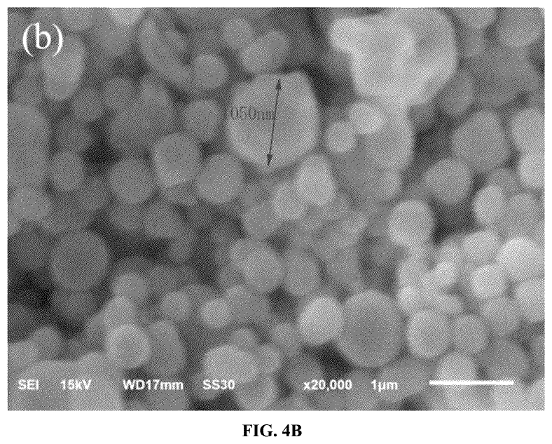

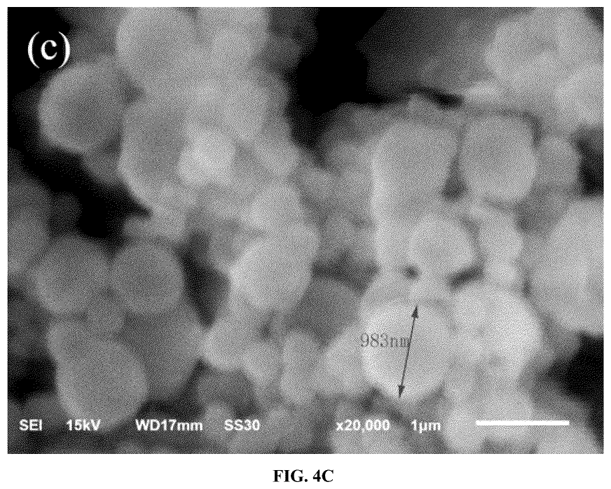

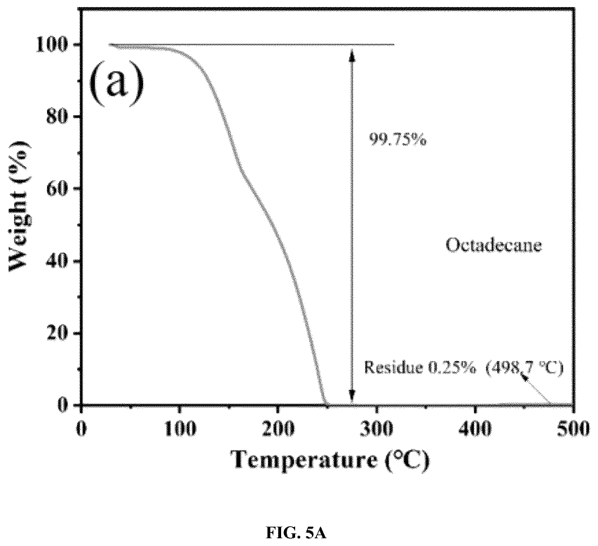

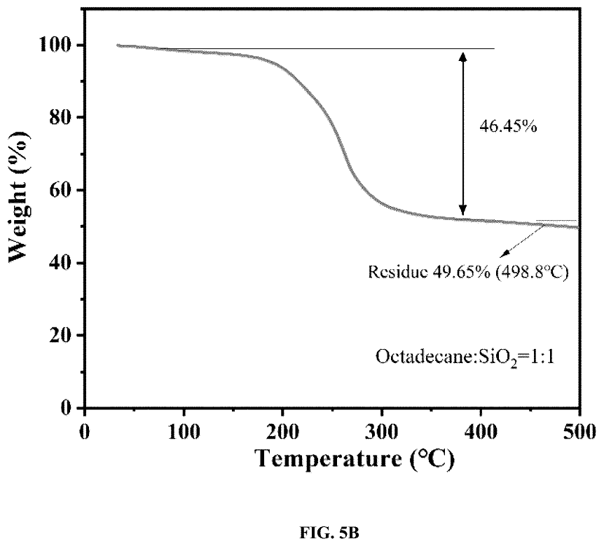

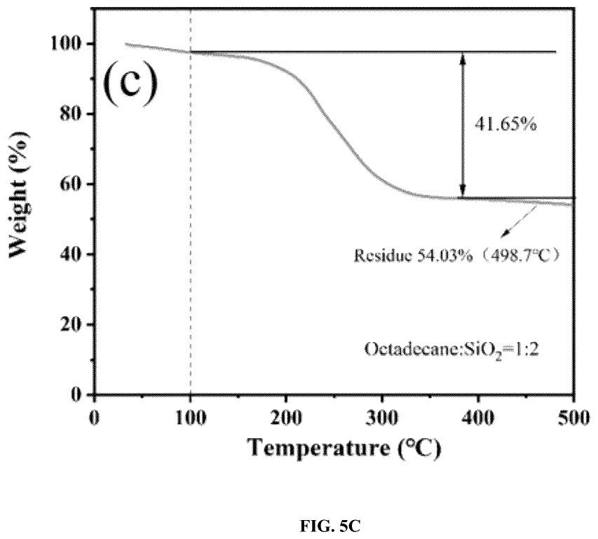

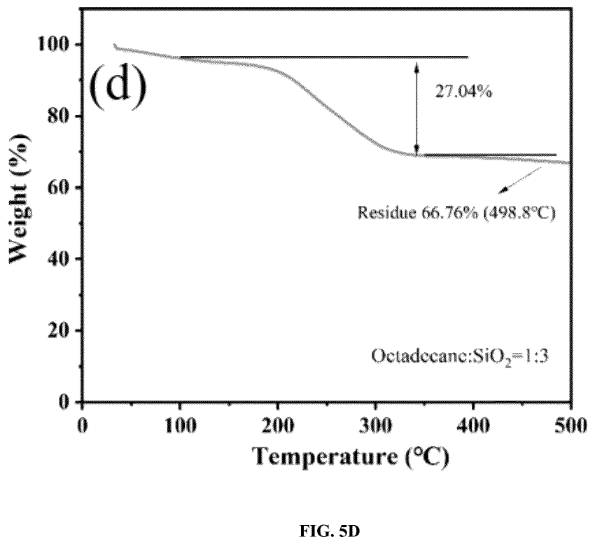

the (a) in the FIG. 1 corresponds to the first embodiment; the (b) in the FIG. 1 corresponds to the first counterpart Embodiment; the (a) in the FIG. 4 corresponds to the first embodiment; the (b) in FIG. 4 corresponds to the fourth embodiment; the (c) in FIG. 4 corresponds to the fifth embodiment; the (a) in FIG. 5 corresponds to the n-octadecane; the (b) in FIG. 5 corresponds to the fifth embodiment; the (c) in FIG. 5 corresponds to the first embodiment; and the (d) in FIG. 5 corresponds to the fourth embodiment.

### DETAILED DESCRIPTION OF THE EMBODIMENTS

The technical solutions in the embodiments of the present invention will be described in detail below in conjunction with the accompanying drawings in the embodiments of the present invention, and it is obvious that the described embodiments are only a part of the embodiments of the present invention and not all of the embodiments. Based on the embodiments in the present invention, all other embodiments obtained by a person of ordinary skill in the art without making creative labor fall within the scope of protection of the present invention.

### Embodiment 1

In the step S1, an emulsification of n-octadecane is conducted. A reagent bottle containing solid n-octadecane was placed in a water bath and melted by heating at 60° C. 2.5 g of n-octadecane was weighed into a mixture of 35 ml of anhydrous ethanol and 70 ml of water, and 0.8 g of hexadecyltrimethylammonium bromide was added, and processed by stirring at 800 rpm for 15 min and then sonicated for 50 min.

In the step S2, a hydrolytic polycondensation of ethyl orthosilicate is conducted. With the peristaltic pump, 5 ml of ethyl orthosilicate was added drop-by-drop to the emulsion of n-octadecane described above, stirred for 1 h in a constant temperature magnetic stirrer at 60° C., 1.25 ml of ammonia was added to adjust the pH of the solution, and stirred for 24 h at 300 rpm at 60° C.

In the step of S3, a centrifugal drying is performed. The obtained sample was transferred to a centrifuge tube and centrifuged at 8000 rpm for 5 min. The supernatant and the n-octadecane that had not been successfully encapsulated were poured off, and the white precipitate was washed with anhydrous ethanol and centrifuged again. The operations were repeated for 3 times, and the centrifuged white precipitate was dried in an oven for 24 h.

TABLE 1
Phase transition enthalpies and corresponding temperatures
for Embodiment 1 samples and n-octadecane

| | | Latent | Crystal- | Latent |
|---|---|---|---|---|
| | Melting | heat of | lization | heat of |
| | point | melting | temperature | condensation |
| | (° C.) | (J/g) | (° C.) | (J/g) |
| The n-octadecane | 27.60 | 159.74 | 7.19 | 125.40 |
| encapsulated in the | | | | |
| SiO₂ microcapsules | | | | |
| The n-Octadecane | 29.92 | 299.76 | 24.27 | 362.56 |

Table 1 The results indicate that the thermal decomposition temperature of the n-octadecane encapsulated in the SiO₂ microcapsule is nearly 50° C. higher than that of n-octadecane, which suggests that the thermal stability of the material can be significantly enhanced by physical protection with the SiO₂ microcapsule structure.

### Counterpart Embodiment 1

The steps in the embodiments are same as that in the first embodiment except for the change of stirring time from 24 h to 4 h in step S2 of the hydrolysis and condensation reaction.

Analysis of Embodiment 1 and Counterpart 1 are shown in FIG. 1, and the results show that the reaction time is too short, the hydrolysis condensation of TEOS has not yet reacted completely on the surface of n-octadecane, so it will get a capsule with a low encapsulation rate, which will result in the collapse of the shell and present an inhomogeneous shape such as a concave shape, but after 4 h of reaction, the basic size of the particles has already been determined and is not growing. The results of the physical phase analysis are shown in FIG. 2, which indicates that the peak widths of the samples with different reaction times are consistent, and the peak values are slightly different, indicating that as the reaction proceeds, the crystalline phase content of the composite material increases.

### Embodiment 2

In the step of S1, an emulsification of n-octadecane is performed. The solid n-octadecane containing reagent bottle was placed in a water bath at 60° C. and heated to melt, and 2.5 g of n-octadecane was weighed into a mixture of 35 ml of anhydrous ethanol and 70 ml of water, and 0.4 g of Tween 80 and 0.6 g of Spectra 80 were added, and stirred at 800 rpm for 15 min and then sonicated for 50 min.

In the step of S2, a hydrolytic polycondensation of ethyl orthosilicate is performed. 5 ml of ethyl orthosilicate was added drop by drop to the emulsion of n-octadecane above with a peristaltic pump, stirred in a magnetic stirrer at a constant temperature of 60° C. for 1 h. 1.25 ml of ammonia was added to adjust the pH of the solution, and stirred at 60° C. for 24 h at 300 rpm;

In the step of S3, a centrifugal drying is performed. The obtained sample was transferred to a centrifuge tube and centrifuged at 8000 rpm for 5 min, the supernatant and the n-octadecane that had not been successfully encapsulated were poured off and washed with anhydrous ethanol, centrifuged again, and the operation was repeated for three times.

Only a small amount of transparent gelatinous precipitate was obtained after the reaction of this embodiment, no white precipitate was obtained, and the white liquid layer (SiO₂, n-octadecane mixture) and the oil phase were obviously delaminated, obviously, the SiO₂ has not been wrapped thereon. The same results were obtained by increasing the heating time of the step S2 or aging it for a certain period of time, which rules out the possibilities of the experimental failures caused by the insufficient aging time and the short heating and stirring duration.

### Embodiment 3

In the step of S1, an emulsification of an n-octadecane is performed. The solid n-octadecane containing reagent bottle was placed in a water bath at 60° C. and heated to melt, and 2.5 g of n-octadecane was weighed into a mixture of 35 ml of anhydrous ethanol and 70 ml of water, and 1 g of Tween 80 and 0.5 g of sodium dodecyl sulphate were added, and stirred at 800 rpm for 15 min and then sonicated for 50 min.

In the step of S2, a hydrolytic polycondensation of ethyl orthosilicate is performed. With the peristaltic pump, 5 ml of ethyl orthosilicate was added drop-by-drop to the emulsion of n-octadecane described above, stirred for 1 h in a constant temperature magnetic stirrer at 60° C., 1.25 ml of ammonia was added to adjust the pH of the solution, and stirred for 24 h at 60° C. at 300 rpm.

In the step of S3, a centrifugal drying is performed. The obtained sample was transferred to a centrifuge tube and centrifuged at 8000 rpm for 5 min. The supernatant and the n-octadecane that had not been successfully encapsulated were poured off, and the white precipitate was washed with anhydrous ethanol and centrifuged again. The operations were repeated 3 times and the centrifuged white precipitate was dried in an oven for 24 h.

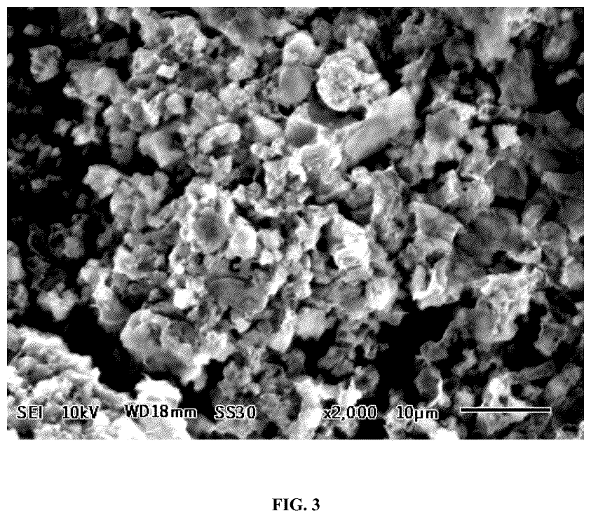

This embodiment also obtained a transparent precipitate, which was analyzed morphologically as shown in FIG. 3, and it can be found intuitively that its particles indicate that the shape is different, resembling random lumps, and the composition is n-octadecane, and the wrapping was failed.

The above results show that the reason for the success of Embodiment 1, in addition to the appropriate mass ratio, may be the main reason is that the HLB value of the emulsifier is similar to the HLB value of n-octadecane (the emulsified body) and the emulsion generated has the best stability.

### Embodiment 4

In the step S1, an emulsification of n-octadecane is performed. The solid n-octadecane containing reagent bottle was placed in a water bath at 60° C. and heated to melt, and 2.5 g of n-octadecane was weighed into a mixture of 35 ml of anhydrous ethanol and 70 ml of water, and 0.8 g of cetyltrimethylammonium bromide was added, and stirred for 15 min at 800 rpm and then sonicated for 50 min.

In the step of S2, a hydrolytic polycondensation of ethyl orthosilicate is performed. With the peristaltic pump, 7.5 ml of ethyl orthosilicate was added drop-by-drop to the emulsion of n-octadecane described above, stirred for 1 h in a constant temperature magnetic stirrer at 60° C., 1.25 ml of ammonia was added to adjust the pH of the solution, and stirred for 24 h at 300 rpm at 60° C.;

In the step of S3, a centrifugal drying is performed. The obtained sample was transferred to a centrifuge tube and centrifuged at 8000 rpm for 5 min, the supernatant and the n-octadecane that had not been successfully encapsulated were poured off, and the white precipitate was washed with anhydrous ethanol and centrifuged again. The operations were repeated for 3 times, and the centrifuged white precipitate were placed in an oven to dry for 24 h.

### Embodiment 5

In the step of S1, an emulsification of n-octadecane is performed. The reagent bottle containing solid n-octadecane was placed in a water bath and melted by heating at 60° C. 2.5 g of n-octadecane was weighed into a mixture of 35 ml of anhydrous ethanol and 70 ml of water, and 0.8 g of hexadecyltrimethylammonium bromide was added, and processed by stirring for 15 min at 800 rpm and then sonicated for 50 min.

In the step of S2, a hydrolytic polycondensation of ethyl orthosilicate is performed. With the peristaltic pump, 2.5 ml of ethyl orthosilicate was added drop-by-drop to the emulsion of n-octadecane described above, stirred for 1 h in a constant temperature magnetic stirrer at 60° C., 1.25 ml of ammonia was added to adjust the pH of the solution, and stirred for 24 h at 300 rpm at 60° C.

In the step of S3, a centrifugal drying is performed. The obtained sample was transferred to a centrifuge tube and centrifuged at 8000 rpm for 5 min. The supernatant and the n-octadecane that had not been successfully encapsulated were poured off, and the white precipitate was washed with anhydrous ethanol and centrifuged again. The operations were repeated for 3 times, and the centrifuged white precipitate was dried in an oven for 24 h.

Electron microscopy was used to analyze the morphology of the materil obtained by the embodiments 1, 4 and 5, and the results are shown in FIG. 4. The thermal properties of embodiments 1, 4 and 5 were analyzed, and the results are shown in FIG. 5.

Combined with the results shown in FIG. 4, it was shown that the microcapsules were mostly spherical in shape, indicating a high encapsulation rate, a relatively complete reaction, and a consistent range of particle sizes, suggesting that changing the core-to-shell ratio would not have a significant effect on the overall morphology of the capsules. Combined with the results shown in FIG. 5, it indicates that the core-shell ratio at the time of reaction is not equal to the mass of the core shell of the capsule formed on behalf of the capsule, but the higher the core-shell ratio, the higher the ratio of the mass of the core shell of the capsule to that of the core material accordingly; at the same time, with the lowering of the core-shell ratio of the composite material to undergo thermal decomposition of the temperature rises slightly, while the composite material is a high-purity SiO₂ when the core-shell ratio is the lowest, when the thermal stability is very good.

This embodiment is only an exemplary description of the patent and does not limit its scope of protection, the field can also be localized changes, as long as it does not exceed the spirit of the patent, are considered equivalent to the patent replacement, are within the scope of protection of the patent.

What is claimed is:

1. A method for preparing a silica-encapsulated nano-phase change material comprising:
S1 emulsification of an n-octadecane; placing a solid n-octadecane containing reagent bottle in a water bath and melting by heating under 60° C., weighting n-octadecane and adding in a mixed liquid phase of anhydrous ethanol and water for 15 min, adding an emulsifying agent is and sonicating for 50 min;
S2 hydrolytic polycondensation of ethyl orthosilicate; adding ethyl orthosilicate drop by drop to the emulsion of n-octadecane by a peristaltic pump, stirring in a magnetic stirrer at a constant temperature of 60° C. for 1 h, adding ammonia to adjust the pH of the solution, and reacting at 60° C.;
S3 centrifugal drying; transferring the obtained sample to a centrifuge tube, centrifuging at 8000 rpm for 5 min, pouring off the upper layer of clear liquid and an unsuccessful wrapped n-octadecane, and washing a white precipitate with anhydrous ethanol, centrifuging and repeating for 3 times, and drying the centrifugated white precipitate in an oven for 24 h.

2. The method of preparing the phase change material according to claim 1, wherein a ratio of the anhydrous ethanol to the water in the step S1 is 1:2.

3. The method of preparing phase change material according to claim 1, wherein a mass ratio of the n-octadecane to the ethyl orthosilicate in the step S1 and the step S2 is 1:1 to 1:3.

4. The method of preparing phase change materials according to claim 1, wherein the emulsifier in the step S1 is one or more of a cetyltrimethylammonium bromide, a Tween 80, a Spectrum 80 and a sodium dodecyl sulfate.
